(19) United States
(12) Patent Application Publication
(10) Pub. No.: US 2026/0217156 A1
(43) Pub. Date: Jul. 30, 2026

(54) POWER TRANSFER SYSTEM

(71) Applicant: TOYOTA JIDOSHA KABUSHIKI KAISHA, Toyota-Shi (JP)

(72) Inventors: Masashi KOBAYASHI, Toyota-Shi (JP); Ippei TAKESUE, Toyota-Shi (JP); Yugo TANAKA, Toyota-Shi (JP)

(73) Assignee: TOYOTA JIDOSHA KABUSHIKI KAISHA, Toyota-Shi (JP)

(21) Appl. No.: 19/395,415

(22) Filed: Nov. 20, 2025

(30) Foreign Application Priority Data
Jan. 14, 2025 (JP) 2025-004722

(51) Int. Cl. B60L 58/27; B60L 53/62; B60L 53/66; B60L 58/12

(52) U.S. Cl. CPC B60L 58/27; B60L 53/62; B60L 53/66; B60L 58/12; B60L 2240/545; B60L 2240/547; B60L 2240/549

(57) ABSTRACT

An ECU executes a process including a step of starting a temperature increase when a battery temperature is lower than a target temperature, a step of stopping the temperature increase when an SOC has reached a stop SOC, a step of resuming the temperature increase when the SOC has reached a resumption SOC, and a step of stopping the temperature increase when the battery temperature has reached the target temperature.

### CROSS-REFERENCE TO RELATED APPLICATION

This application claims priority to Japanese Patent Application No. 2025-004722 filed on Jan. 14, 2025. The disclosure of the above-identified application, including the specification, drawings, and claims, is incorporated by reference herein in its entirety.

### BACKGROUND

### 1. Technical Field

The present disclosure relates to a power transfer system.

### 2. Description of Related Art

There is known a technology for a power transfer system in which an on-board power storage device is connected to a power transfer station connected to a power grid etc. to transfer electric power. For example, Japanese Unexamined Patent Application Publication No. 2022-116971 (JP 2022-116971 A) discloses a technology for sending a notification of information on an inquiry about whether to stop a power transfer system when the magnitude of electric power exchanged between a power storage device and equipment is smaller than a threshold value, when the time is within a time frame in which the amount of electric power generated by a solar power generation device is smaller than a threshold value, or when the time is within a time frame in which the electricity rate is lower than those in the other time frames of a day and the power storage device is fully charged.

### SUMMARY

In the power transfer system described above, for example, when the temperature of the on-board power storage device is low before the power storage device is charged, control may be executed to increase the temperature of the power storage device using a temperature increasing device. When the electric power output from a power transfer station by a user is limited to electric power lower than the electric power required to operate the temperature increasing device, however, there is a possibility that the electric power of the power storage device is consumed, the remaining charge level of the power storage device decreases, and then the electric power cannot be transferred to the power grid using the power storage device.

The present disclosure has been made to solve the above problem, and has an object to provide a power transfer system that suppresses a decrease in the remaining charge level of an on-board power storage device to a level at which power transfer is limited.

A power transfer system according to an aspect of the present disclosure includes a vehicle including a power storage device, and a power transfer station configured to perform power transfer between the vehicle and the power transfer station. The vehicle includes a first acquisition device configured to acquire a temperature of the power storage device, a second acquisition device configured to acquire a remaining charge level of the power storage device, a temperature increasing device configured to increase the temperature of the power storage device by consuming electric power, and a control device configured to control the temperature increasing device. The control device is configured to set a first threshold value of the remaining charge level for stopping an operation of the temperature increasing device to a value higher than a remaining charge level of the power storage device at which the power transfer is limited.

In this way, even if the remaining charge level of the power storage device decreases during the power transfer and during the operation of the temperature increasing device, the operation of the temperature increasing device can be stopped when the first threshold value is reached. Thus, it is possible to reduce the occurrence of the case where the remaining charge level of the power storage device reaches the level at which the power transfer is limited.

In one embodiment, the control device is configured to resume the operation of the temperature increasing device when the remaining charge level is equal to or higher than a second threshold value that is higher than the first threshold value after the operation of the temperature increasing device has been stopped.

In this way, when the remaining charge level is equal to or higher than the second threshold value, the operation of the temperature increasing device can be resumed. Therefore, the temperature of the power storage device can be increased to reach the temperature suitable for power transfer.

In one embodiment, the power transfer station is configured to notify the vehicle about an upper limit value of outputtable electric power, and supply electric power set by a user to the vehicle. The control device is configured to set the first threshold value when the electric power supplied from the power transfer station is lower than electric power required during the operation of the temperature increasing device.

In this way, when the electric power supplied from the power transfer station is lower than the electric power required during the operation of the temperature increasing device, the remaining charge level of the power storage device may decrease during the power transfer. By setting the first threshold value, it is possible to reduce the occurrence of the case where the remaining charge level of the power storage device reaches the level at which the power transfer is limited.

According to the present disclosure, it is possible to provide the power transfer system that suppresses a decrease in the remaining charge level of the on-board power storage device to a level at which power transfer is limited.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the configuration of a power transfer system;

FIG. 2 illustrates an example of information exchanged through communication between a power transfer station and a vehicle;

FIG. 3 illustrates an example of a change in SOC of a battery when the temperature increase continues;

FIG. 4 is a flowchart showing an example of a process to be executed by an ECU; and

FIG. 5 shows an example of changes in battery temperature and SOC during power transfer.

### DETAILED DESCRIPTION OF EMBODIMENTS

An embodiment of the present disclosure will be described in detail below with reference to the drawings. The same or corresponding portions are denoted by the same signs throughout the drawings, and description thereof will not be repeated.

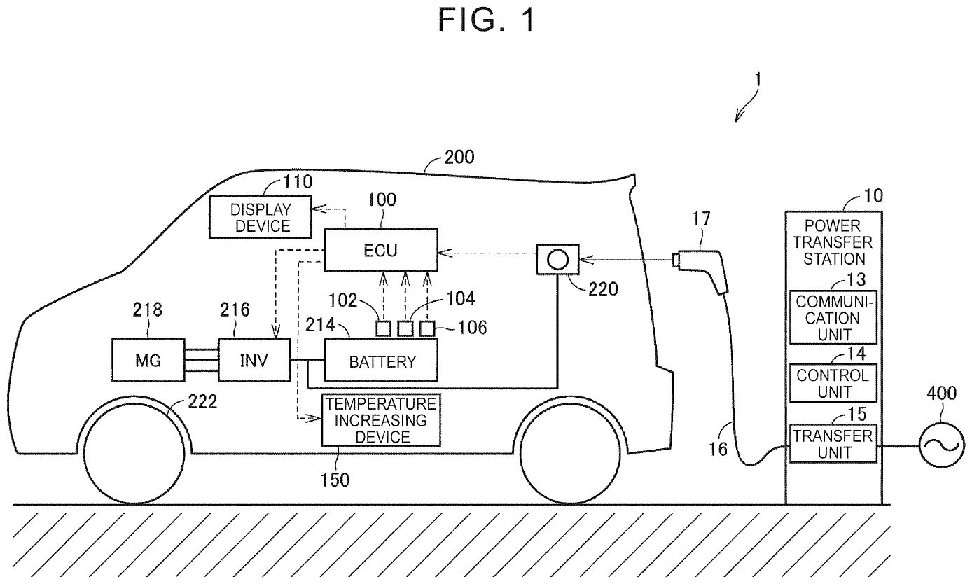

An example of the configuration of a power transfer system 1 according to the present embodiment will be described below. FIG. 1 shows an example of the configuration of the power transfer system 1. As shown in FIG. 1, the power transfer system 1 includes a vehicle 200 and a power transfer station 10 located outside the vehicle 200. The vehicle 200 may be any vehicle that can transfer electric power to external facilities, and may be an electrified vehicle such as a battery electric vehicle or a plug-in hybrid electric vehicle.

The vehicle 200 includes an electronic control unit (ECU) 100 that is a control device, a display device 110, a temperature increasing device 150, a battery 214, an inverter 216, a motor generator (MG) 218, and an inlet 220.

The battery 214 may be any rechargeable power storage device, and may be a secondary battery such as a nickel metal hydride battery or a lithium ion battery with a liquid or solid electrolyte, or a large-capacity capacitor may be used instead of the battery 214.

The inverter 216 is configured to convert direct current power of the battery 214 and alternating current power of the MG 218 in both directions in response to control signals from the ECU 100.

The MG 218 is a drive source that drives drive wheels 222 of the vehicle 200, and is a three-phase alternating current rotary electric machine etc. The MG 218 functions as an electric motor that causes the vehicle 200 to travel using the electric power of the battery 214, and as a generator that generates electric power (e.g., regenerative power) to charge the battery 214.

The inlet 220 has a shape that allows a connector 17 of the power transfer station 10 to be attached. The inlet 220 is electrically connected to the battery 214.

A voltage sensor 102, a current sensor 104, and a temperature sensor 106 that acquire the voltage, current, and temperature of the battery 214 are connected to the ECU 100. The ECU 100 includes a central processing unit (CPU) and a memory (neither of which is shown). The ECU 100 controls each device such that the vehicle 200 is in a desired state based on signals received from each sensor and information such as maps and programs stored in the memory.

The ECU 100 has a function of successively calculating a state of charge (SOC) that indicates the remaining charge level of the battery 214 based on values detected by the voltage sensor 102, the current sensor 104, and the temperature sensor. As a method for calculating the SOC, various known methods can be used, such as a method based on current integration (coulomb counting) or a method based on open circuit voltage (OCV) estimation. The ECU 100 is configured to communicate with a communication unit 13 of the power transfer station 10 described later.

The display device 110 is, for example, a display unit of a touch panel display provided near the driver's seat. The display unit is, for example, a liquid crystal display (LCD) or an organic electro-luminescence (EL) display.

The temperature increasing device 150 is configured to increase the temperature of the battery 214 in response to a control signal from the ECU 100. The temperature increasing device 150 includes an electric heater that uses the electric power of the battery 214 for heating. The temperature increasing device 150 may include, for example, in addition to the electric heater, a radiator that can exchange heat with the battery 214, a heat exchanger that can exchange heat with a heat source (e.g., an engine, a heater, or other electrical equipment), a medium (e.g., a coolant or gas), a pump that feeds the medium under pressure, and a medium passage through which the medium flows.

When increasing the temperature of the battery 214, the ECU 100 operates the temperature increasing device 150. For example, the ECU 100 operates the temperature increasing device 150 when the temperature of the battery 214 is lower than a lower limit value of a predetermined temperature range including a target temperature.

When the temperature of the battery 214 is within the predetermined temperature range, the ECU 100 stops the temperature increasing device 150. The temperature increasing device 150 is operable using at least one of, for example, electric power supplied from the vehicle 200 to the inlet 220 (electric power from an external power supply) and electric power supplied from the battery 214.

The power transfer station 10 includes the communication unit 13, a control unit 14, a transfer unit 15, a cable 16, and the connector 17. For example, the power transfer station 10 transfers electric power from a system power supply 400 to the battery 214 of the vehicle 200 to charge the battery 214, or transfers electric power from the battery 214 to the system power supply 400 to discharge the battery 214.

When the connector 17 is connected to the inlet 220 of the vehicle 200, the communication unit 13 performs wired communication such as power line communication, control area network (CAN) communication, or LAN communication with the ECU 100 of the vehicle 200 via the cable 16. The communication may be wireless communication of various standards (e.g., Wi-Fi).

The control unit 14 controls the operation of the transfer unit 15 (e.g., transfer voltage and transfer current) based on a control signal received from the ECU 100. The control unit 14 includes a CPU and a memory (neither of which is shown). The control unit 14 controls the transfer unit 15 based on information received from the vehicle 200 using the communication unit 13 and information such as maps and programs stored in the memory.

In response to a control signal from the control unit 14, the transfer unit 15 converts alternating current power from the system power supply 400 that constitutes the power grid into direct current power, and converts direct current power from the battery 214 into alternating current power. One end of the cable 16 is connected to the transfer unit 15. The other end of the cable 16 is connected to the connector 17.

The connector 17 has a shape that allows it to be attached to the inlet 220. When the connector 17 is attached to the inlet 220, a first state in which direct current power can be supplied from the transfer unit 15 to the battery 214 or a second state in which alternating current power can be supplied from the transfer unit 15 to the system power supply 400 is set based on a control signal received from the ECU 100 by the control unit 14. For example, when requesting external charging, the ECU 100 transmits a control signal to the control unit 14 to set the first state when the connector 17 is attached to the inlet 220. For example, when requesting discharging to the power transfer station 10, the ECU 100 transmits a control signal to control unit 14 to set the second state when the connector 17 is attached to the inlet 220.

For example, when the SOC of the battery 214 is lower than a threshold value, the ECU 100 requests quick charging. For example, in a case where power transfer is performed between the vehicle 200 and a facility (e.g., a home) where the power transfer station 10 is installed (hereinafter referred to as V2H: Vehicle to Home), the ECU 100 requests discharging when the battery 214 is to be used as a power supply for the facility, and requests charging when surplus power is to be stored in the battery 214.

During power transfer using the battery 214, the ECU 100 acquires the SOC of the battery 214 and the temperature of the battery 214 (hereinafter referred to as battery temperature) using values detected by the voltage sensor 102, the current sensor 104, and the temperature sensor 106.

In the power transfer system 1 described above, when the temperature of the battery 214 is low before the battery 214 is charged, control may be executed to increase the temperature of the battery 214 using the temperature increasing device 150. When the electric power output from the power transfer station 10 by a user is limited to electric power lower than the electric power required to operate the temperature increasing device 150, however, there is a possibility that the electric power stored in the battery 214 is consumed, the SOC of the battery 214 decreases, and then V2H cannot be performed using the battery 214.

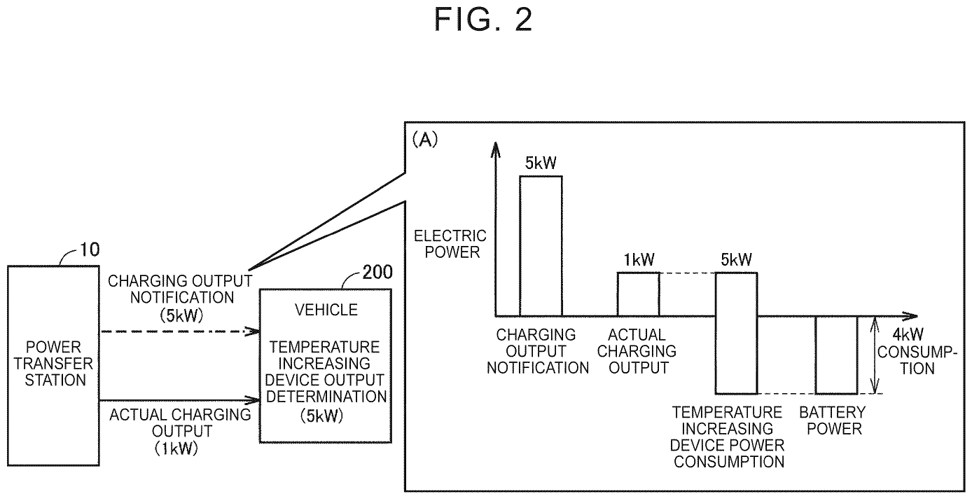

FIG. 2 illustrates an example of information exchanged through communication between the power transfer station 10 and the vehicle 200. When the connector 17 is attached to the inlet 220, as shown in FIG. 2, communication is performed from the power transfer station 10 to the vehicle 200 (specifically, the ECU 100) using power line communication. At this time, the power transfer station 10 notifies the ECU 100 about information on an available charging output (upper limit output). In FIG. 2, the ECU 100 is notified about information indicating that the available charging output is, for example, 5 kW.

In the power transfer station 10, the output of the power transfer station may be limited by the user to electric power lower than the upper limit output. For example, when the electric power is limited to 1 kW, the power transfer station 10 outputs 1 kW of electric power to the vehicle 200. In the ECU 100 of the vehicle 200, for example, when the battery temperature is lower than the target temperature, determination is made to operate the temperature increasing device 150 with 5 kW of electric power using information on the upper limit output from the power transfer station 10.

In this case, as shown in part (A) of FIG. 2, the charging output notification is an output notification of 5 kW, but the actual charging output is 1 kW, and the electric power consumed by the temperature increasing device 150 is 5 kW, resulting in a net power consumption of 4 kW in the battery 214. As a result, the SOC of the battery 214 continues to decrease while the temperature is being increased using the temperature increasing device 150.

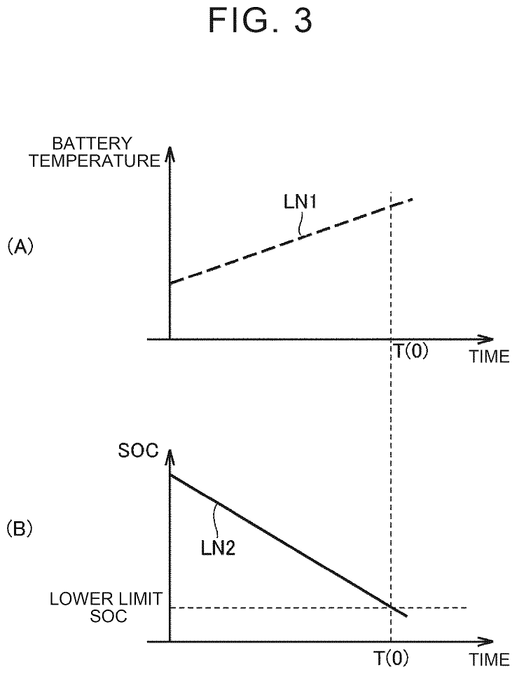

FIG. 3 illustrates an example of a change in SOC of the battery 214 when the temperature increase continues. The vertical axis in part (A) of FIG. 3 represents the battery temperature. The vertical axis in part (B) of FIG. 3 represents the SOC. The horizontal axis in each of parts (A) and (B) of FIG. 3 represents time. LN1 (dashed line) in part (A) of FIG. 3 shows an example of the change in battery temperature over time. LN2 (continuous line) in part (B) of FIG. 3 shows an example of the change in SOC over time.

For example, when the connector 17 is attached to the inlet 220 and the battery temperature is lower than the predetermined temperature range, the ECU 100 operates the temperature increasing device 150. As a result of the operation of the temperature increasing device 150, the battery temperature increases over time as shown by LN1 in part (A) of FIG. 3.

The operation of the temperature increasing device 150 consumes the electric power of the battery 214. Therefore, as shown by LN2 in part (B) of FIG. 3, the SOC of the battery 214 decreases over time. As a result, at time T(0), the SOC of the battery 214 may fall below a lower limit SOC. The lower limit SOC is a lower limit value of a range of the SOC of the battery 214 in which power transfer is not limited (i.e., an upper limit value of a lower range of the SOC of the battery 214 in which power transfer is limited). Therefore, when the SOC of the battery 214 falls below the lower limit SOC, there is a possibility that the electric power of the battery 214 cannot be supplied to the power grid and V2H cannot be performed.

In the present embodiment, the ECU 100 sets a first threshold value of the SOC (i.e., a stop SOC) for stopping the operation of the temperature increasing device 150 to a value higher than the SOC of the battery 214 at which power transfer is limited (i.e., a value higher than the lower limit SOC).

In this way, even if the SOC of the battery 214 decreases during power transfer, the operation of the temperature increasing device 150 can be stopped when the first threshold value is reached. Therefore, it is possible to suppress a decrease in the SOC to the value at which power transfer is limited (i.e., a value lower than the lower limit SOC).

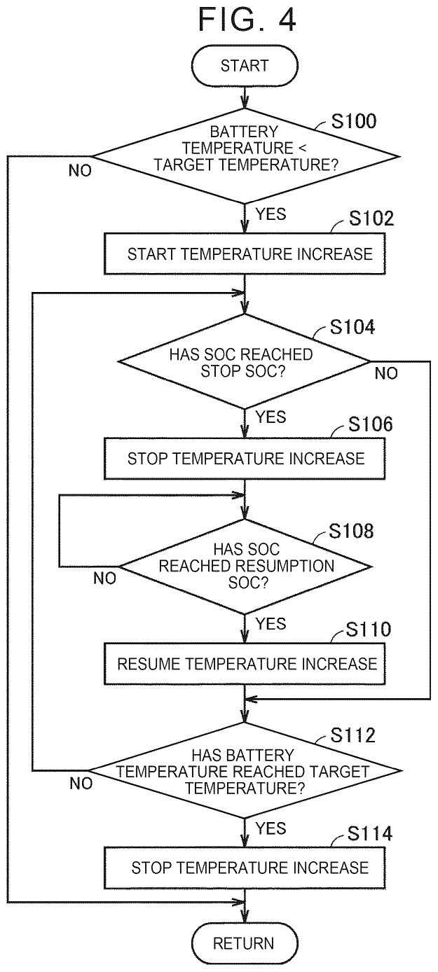

An example of a process to be executed by the ECU 100 will be described below with reference to FIG. 4. FIG. 4 is a flowchart showing the example of the process to be executed by the ECU 100.

In step (hereinafter “step” will be abbreviated as “S”) 100, the ECU 100 determines whether the battery temperature is lower than the target temperature. The target temperature may be a predetermined value within a temperature range in which deterioration does not accelerate even when power transfer is performed using the battery 214, or may be a value set by acquiring the outside air temperature and using a map that shows the relationship between the outside air temperature and the target temperature. The ECU 100 acquires the battery temperature using the temperature sensor 106. When determination is made that the battery temperature is lower than the target temperature (YES in S100), the process proceeds to S102.

In S102, the ECU 100 starts increasing the temperature. That is, the ECU 100 operates the temperature increasing device 150. The process then proceeds to S104.

In S104, the ECU 100 determines whether the SOC of the battery 214 has reached the stop SOC. The stop SOC is a predetermined value that is higher than the lower limit value of the range of the SOC in which the battery 214 can be used for V2H (hereinafter referred to as lower limit SOC). The lower limit SOC is, for example, a value higher than the lower limit value of the usable SOC range of the battery 214, and is the lower limit value of the SOC range that is adapted through experiments etc. such that deterioration does not accelerate even when the battery 214 is used for V2H. For example, the ECU 100 may acquire the outside air temperature and set the stop SOC using a map that shows the relationship between the outside air temperature and the stop SOC. When the ECU 100 determines that the SOC of the battery 214 has reached the stop SOC (YES in S104), the process proceeds to S106.

In S106, the ECU 100 stops the temperature increase. That is, the ECU 100 stops the operation of the temperature increasing device 150. The process then proceeds to S108.

In S108, the ECU 100 determines whether the SOC of the battery 214 has reached a resumption SOC. The resumption SOC is a predetermined value that is at least higher than the stop SOC. The resumption SOC may be set to a value that is higher than the stop SOC by a predetermined value. When determination is made that the SOC of the battery 214 has reached the resumption SOC (YES in S108), the process proceeds to S110.

In S110, the ECU 100 resumes the temperature increase. That is, the ECU 100 operates the temperature increasing device 150 again. The process then proceeds to S112. Also when the SOC of the battery 214 has not reached the stop SOC (NO in S104), the process proceeds to S112.

In S112, the ECU 100 determines whether the battery temperature has reached the target temperature. When determination is made that the battery temperature has reached the target temperature (YES in S112), the process proceeds to S114.

In S114, the ECU 100 stops the temperature increase. That is, the ECU 100 stops the operation of the temperature increasing device 150. The process then ends. When determination is made that the battery temperature is equal to or higher than the target temperature (NO in S100), the process ends. When determination is made that the SOC has not reached the resumption SOC (NO in S108), the process returns to S108. When determination is made that the battery temperature has not reached the target temperature (NO in S112), the process returns to S104.

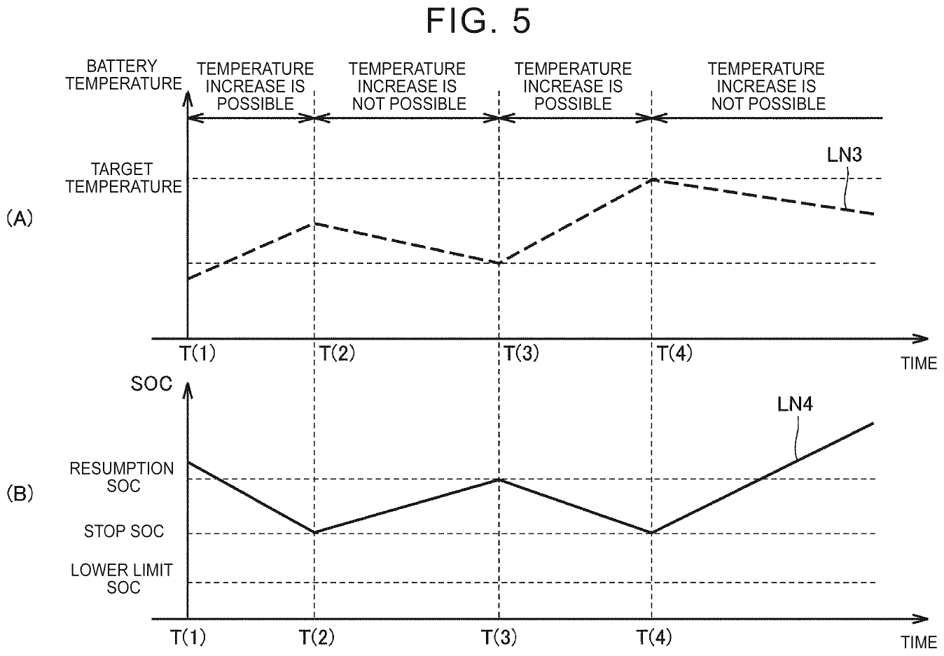

The operation of the power transfer system 1 according to the present embodiment based on the above structure and flowchart will be described with reference to FIG. 5. FIG. 5 shows an example of changes in battery temperature and SOC during power transfer. The vertical axis in part (A) of FIG. 5 represents the battery temperature. The vertical axis in part (B) of FIG. 5 represents the SOC. The horizontal axis in each of parts (A) and (B) of FIG. 5 represents time. LN3 (dashed line) in FIG. 5 shows the change in battery temperature over time. LN4 (continuous line) in FIG. 5 shows the change in SOC of the battery 214 over time.

For example, it is assumed that the connector 17 is connected to the inlet 220 of the vehicle 200 and the ECU 100 requests the power transfer station 10 for charging.

At time T(1), the charging power is limited to 1 kW at the power transfer station 10, and the battery temperature is lower than the target temperature as shown by LN3 in part (A) of FIG. 5. At this time, the power transfer station 10 notifies the vehicle 200 about information indicating that the upper limit value of the charging output is 5 kW, and the charging power limited to 1 kW is supplied to the vehicle 200.

Since the battery temperature is lower than the target temperature (YES in S100), the ECU 100 operates the temperature increasing device 150 to start increasing the temperature (S102). When the temperature increase starts, the electric power supplied from the power transfer station 10 is consumed by the temperature increasing device 150.

Therefore, during a period from time T(1) to time T(2), the battery temperature increases as shown by LN3 in part (A) of FIG. 5, and the SOC of the battery 214 decreases as shown by LN4 in part (B) of FIG. 5.

When the SOC of the battery 214 has reached the stop SOC at time T(2) (YES in S104), the operation of temperature increasing device 150 is stopped (S106). When the operation of the temperature increasing device 150 is stopped, the electric power supplied from the power transfer station 10 is supplied to the battery 214, and the battery 214 is therefore charged.

Therefore, during a period from time T(2) to time T(3), the battery temperature decreases as shown by LN3 in part (A) of FIG. 5, and the SOC of the battery 214 increases as shown by LN4 in part (B) of FIG. 5.

When the SOC of the battery 214 has reached the resumption SOC at time T(3) (YES in S108), the temperature increasing device 150 is operated again to resume the temperature increase (S110). When the temperature increase resumes, the electric power supplied from the power transfer station 10 is consumed by the temperature increasing device 150 again.

Therefore, during a period from time T(3) to time T(4), the battery temperature increases as shown by LN3 in part (A) of FIG. 5, and the SOC decreases as shown by LN4 in part (B) of FIG. 5.

When the battery temperature has reached the target temperature at time T(4) (YES in S112), the temperature increase is stopped (S114). When the temperature increase is stopped, the electric power supplied from the power transfer station 10 is supplied to the battery 214, and the battery 214 is therefore charged.

Therefore, at time T(4) onward, the battery temperature decreases as shown by LN3 in part (A) of FIG. 5, and the SOC increases as shown by LN4 in part (B) of FIG. 5.

In this way, the operation of the temperature increasing device 150 is limited to the range before the SOC reaches the stop SOC, thereby suppressing a decrease in the SOC of the battery 214 to the lower limit SOC.

As described above, in the power transfer system 1 of the present embodiment, even if the SOC of the battery 214 decreases during power transfer, the operation of the temperature increasing device 150 can be stopped when the stop SOC is reached. Therefore, it is possible to suppress a decrease in the SOC to the value at which V2H is limited below the lower limit SOC. Thus, it is possible to provide the power transfer system that suppresses a decrease in the remaining charge level of the on-board power storage device to a level at which power transfer is limited.

By resuming the operation of the temperature increasing device 150 when the SOC has reached the resumption SOC that is higher than the stop SOC after the stop of the operation of the temperature increasing device 150, the temperature of the battery 214 can be increased to reach the target temperature.

Modifications will be described below.

The above embodiment illustrates that the operation of the temperature increasing device 150 is stopped when the SOC has reached the preset stop SOC while the temperature increasing device 150 is operating. However, the ECU 100 may set the stop SOC, for example, when the electric power supplied from the power transfer station 10 is lower than the power consumption of the temperature increasing device 150 in operation.

In this way, when electric power higher than the electric power supplied from the power transfer station 10 is set as the electric power required during the operation of the temperature increasing device 150, it is possible to suppress a decrease in the SOC below the lower limit SOC.

The above embodiment illustrates that the operation of the temperature increasing device 150 is resumed when the stop SOC is reached. However, the operation is not particularly limited to this operation. For example, the temperature increasing device 150 may be controlled such that the SOC is maintained at the stop SOC when the stop SOC is reached.

The above embodiment illustrates that the resumption SOC is set to a value obtained by adding a predetermined value to the stop SOC. However, the resumption SOC may be calculated by adding, for example, a ΔSOC corresponding to the amount of electric power required to increase the temperature by a difference ΔT between the current battery temperature and the target temperature to the stop SOC. In this way, it is possible to suppress a decrease in the SOC of the battery 214 again to the stop SOC before the battery temperature reaches the target temperature. It is possible to suppress repetition of the increase and decrease in the battery temperature.

All or part of the modifications described above may be combined as appropriate.

The embodiment disclosed herein should be considered to be exemplary in all respects and not restrictive. The scope of the present disclosure is set forth in the claims rather than in the above description of the embodiment, and is intended to include all modifications within the meaning and scope equivalent to the claims.

What is claimed is:

1. A power transfer system comprising:
a vehicle including a power storage device; and
a power transfer station configured to perform power transfer between the vehicle and the power transfer station, wherein
the vehicle includes:
a first acquisition device configured to acquire a temperature of the power storage device;
a second acquisition device configured to acquire a remaining charge level of the power storage device;
a temperature increasing device configured to increase the temperature of the power storage device by consuming electric power; and
a control device configured to control the temperature increasing device, and
the control device is configured to set a first threshold value of the remaining charge level for stopping an operation of the temperature increasing device to a value higher than a remaining charge level of the power storage device at which the power transfer is limited.

2. The power transfer system according to claim 1, wherein the control device is configured to resume the operation of the temperature increasing device when the remaining charge level is equal to or higher than a second threshold value that is higher than the first threshold value after the operation of the temperature increasing device has been stopped.

3. The power transfer system according to claim 1, wherein:
the power transfer station is configured to notify the vehicle about an upper limit value of outputtable electric power, and supply electric power set by a user to the vehicle; and
the control device is configured to set the first threshold value when the electric power supplied from the power transfer station is lower than electric power required during the operation of the temperature increasing device.
